(19) United States
(12) Patent Application Publication
(10) Pub. No.: US 2008/0082417 A1
(43) Pub. Date: Apr. 3, 2008

(54) ADVERTISING AND FULFILLMENT SYSTEM

(76) Inventor: Mark W. Publicover, Saratoga, CA (US)

Correspondence Address: KLARQUIST SPARKMAN, LLP, 121 SW SALMON STREET, SUITE 1600, PORTLAND, OR, 97204, US

(21) Appl. No.: 11/831,919

(22) Filed: Jul. 31, 2007

Related U.S. Application Data
(60) Provisional application No. 60/820,943, filed on Jul. 31, 2006.

(51) Int. Cl. G06Q 30/00

(52) U.S. Cl. 705/14

(57) ABSTRACT

A method is provided for a method of purchasing goods online, which allows end users to receive money in return for browsing the internet and making purchases. According to the features of the invention, the end user enters a profile into YOUniverse, which is uploaded to the database. The user then logs in to search for items and the advertisement search results are specific to the end user's profile. The user controls the amount of information in their profile; however, more information yields better advertisement results and more money.

### CROSS REFERENCE TO RELATED APPLICATION

This claims the benefit of U.S. Provisional application No. 60/820,943, filed Jul. 31, 2006, the contents of which are incorporated herein in their entirety.

### SUMMARY

The present invention concerns systems for selling goods online via a global computer network.

### BRIEF DESCRIPTION OF THE DRAWING

FIG. 1 is a flowchart of a system for purchasing goods online.

### DETAILED DISCLOSURE

Keyword advertising is booming across the internet today, and behind the scenes, money changes hands with every click of a user's mouse. Since the end user fuels the economics of online advertising, shouldn't a portion of the generated cash flow be directed towards that user? Logically, he or she is entitled to a piece of the action. Enter U-Ad/YOUniverse.

YOUniverse system is constructed as a coop, owned by its users. Thus, any profit generated that is not fed back into the growth of the company is distributed among its members, the end users.

When signing up for YOUniverse, the end user downloads a profile generator to the hard drive and a customizable profile is securely stored for use by the YOUniverse engine.

A key to this profile is that it is completely up to the individual user how much information to provide. There are NO required fields except for the most standard information to set up a deposit/credit account with YOUniverse.

Beyond this, any information provided by the end user performs two main functions:
1. Enhances his click value to the advertiser, thus increasing the amount of money the user will make off of each click.
2. Increases the relevance of the advertisements shown in response to each keyword, potentially saving the user the time and energy of browsing by pointing him more directly towards what he wants.

Once created, the user profile is uploaded to the coop's user profile database. However, this profile database is dynamic, and any alterations the user wishes to make to the desktop profile will automatically upload to the online user profile database.

The search engine page has a standard, simple search engine interface for use as a standard search engine. It also has a user login option on the side. A user can only make money when he is logged into U-Ad. The standard search engine option may be useful for allowing people to get comfortable with the site and brand name before signing up.
Possibility of auto-login of some kind?
   U-Ad browser
   Password storage
   Homepage

Once logged in, the user can get paid while browsing, as well as manage his online U-Dollars account. The U-Dollars account works as a completely self-sufficient online banking system to add another level of security to online transactions by filtering them all through the U-Ad system. The online retailer no longer obtains any information from the end user during the transaction because the purchase is paid for using U-Dollars and paid out through YOUniverse. This further protects the end user from unsuspectingly giving out personal information and compels retailers/advertisers to join the YOUniverse, because otherwise they cannot gather information about the types of users buying their products.

How the YOUniverse U-Dollars account online banking system works:
Credit account comes automatic with YOUniverse signup to track U-Dollars earned through browsing
Users can purchase additional U-Dollars to be used on any online transaction
   Protects information from retailer
   Verifies follow-through conversion on keyword search intentions, boosts click quality
The YOUniverse credit card can be ordered to use U-Dollars in physical transactions
   Also verifies purchases from “Brick & Mortar” retailers, boosts click quality

The search bar resembles any other search engine. Beneath the search bar, however, is a list of possible intentions that the user can click to tailor the search results and advertisements to his needs for that keyword search:
Definite Buyer
   Brick and Mortar buyer?
   Increases click value to local advertisers, decreases to others
Potential Buyer/Price Comparison
   Time frames to estimate when it will be bought
Research to Buy
   Increases appeal to informational sites
Just Browsing
Rather Not Say
   Advertisers will determine their own Max CPC (cost per click) for unspecified users just like standard search engine

After an intention is specified and the keyword search is submitted, the results are organized according to a user-specified ranking of factors. The advertisement results are dynamic columns that can be reorganized and reranked by:
Click Value (amount that advertisers are willing to pay for your click)
   Determined by advertiser, but based on specificity and details of user profile
Relevancy (as determined by normal search engine relevancy)
Product Price (if specific product)
Focus Spectrum—popularity among group of similar users, as specified by end user according to:
   Interests
   Income
   Demographic

The ads displayed in response to a search query have a few additional features compared to other search engine advertisements. Underneath the standard ad display, the YOUniverse ads display:
Click value
Focus Spectrum statistics

The Focus Spectrum is one of the most dynamic and uniquely appealing aspects of the YOUniverse search engine. In the profile generator, users specify not only their personal information, but the range of interests to which they would like their ads tailored. For example, a high-income user might want to only view ads for high-end consumer products. Rather than allow the advertiser to determine what the user wants to see, the engine uses a statistical grouping formula to determine other users with similar profiles in the specified area. Thus, a high-income user who selects income as a key focus spectrum factor would see the click and purchase choices of other high-income users displayed beneath the advertisements. The statistics show the percentage of similar users who decided to click on the product and the smaller percentage that followed through with a conversion.

The user also specifies the range of the Focus Spectrum to narrow or broaden the focus group. A simple focus statistics toolbar above the listing of advertisements has a customizable percentage that jumps between discreet amounts to change the range of the focus group. As the user expands or restricts the focus group size, the engine recalculates the relevancy of advertisements and adjusts their rankings accordingly.

All of the ads displayed in response to search queries are preapproved and within the YOUniverse network to ensure end user privacy in all click-throughs from a YOUniversal search. Our software/transfer page interface checks for cookies on landing sites to prevent pages within the ad network from tracking end users.

Click Value

A user's click value directly affects the amount that user is offered by advertisers for clicking on an ad. The click value is based on:
Click quality—loosely determined by: (# of conversions)/(# of clicks)×100%
Demographic
Income level
Interests
Geographic location
Search Intentions
Any other profile information that the end user may provide

The click quality formula shows that the longer a user browses without making any purchases or other types of advertiser-defined conversions (leads, signups, page views, etc.), the lower the user's quality score drops.
Clicks always have an integer value (1 click=1 ad)
Conversions have variable values, not necessarily integers.
   For example:
   Sale=1
   Newsletter/Subscription=0.5
   Lead (request for follow-up call)=0.75
   Page View (length of visit)=0.05 ×(# of pages viewed after landing page)

Each advertiser can specify what aspects of a user's profile most enhance the click value to that advertiser. Thus, advertiser's can target demographics, income levels, interests, geographic locations, and search intentions to fit their specific product or goal, but only for each individual end user insofar as that user supplies the information. However, the advertiser can not obtain the identity of the specific end user. This is a part of the security promise of the YOUniverse system.

Focus Spectrum

The focus spectrum uses complex statistical analysis of end user profile data to quantify the similarity of two users. The end user specifies what similarities are most important to him or her, and each keyword search groups other user data accordingly. The focus spectrum can be shifted based on:
Income
Demographic
Interests/Hobbies
Geographic location (IP address)
Conversion Rate
   Frequent Buyer
   Occasional Buyer
   Brick and Mortar Buyer
   Rare Buyer

One or more factor can be selected to filter the advertisements even more thoroughly. For example, let's say an 18 year old female is searching for digital cameras online. The focus spectrum uses the groupings according to her demographic (16-20, persay) and expressed interest in professional photography to quantify the relevancy of the advertisements based on other similar users. The resulting ad rankings display the advertisements for higher-end cameras that garnered the most click-throughs and conversions among the 16-20 year old demographic. If she wanted to expand the search to high-end digital cameras among all ages, she could deselect the demographic factor and focus solely on the most popular and successful advertisements among those with an interest in professional photography.
List the value of end user's click underneath the ad
   States amount paid to get through and the determined relevancy factor
Focus spectrum: Based on statistical data about other users with similar profile
   Personalized data to provide information on other conversion profiles
Variable matching—within 5%, 10%, etc.
Ad matrix—customizable ad ranking
   More robust targeting mechanism for the end user, not the advertiser
      Makes transparent the behind-the-scenes workings of Google and other search engines
      Can view statistics for other buyers without revealing the identity of those other buyers
   Can prioritize ad rankings by:
      Price (that advertisers are willing to pay for your click)
      Relevancy
      Focus Spectrum (based on end user-specified group of similar users)
         Interests
      Intention (serious buyer, research, etc.)
Privacy—advertisers see only delivery #'s for UPS, not personal buyer info
   Complete self-sufficient banking online allows complete anonymity for end user
      Buy online $ through Cashcow credit card, spend the $ on online products, retailer ships to UPS
      UPS ships to local address based on unique scan code
         Code changes with every transaction
Bonuses for survey information provided in addition to click/conversion dollars
   Lead bonuses—newsletters, subscriptions, etc.
Time-dependent click value
   Model for checking veracity of user click intention
      For example, if claim “Definite Buyer,” the user will be paid the full amount promised by the advertiser only if they follow through with a conversion within the given time frame
      If the user does not follow through, the initial $X paid for the amount will be cut to a fraction determined by the advertiser
         Retailer can also choose not to cut cost no matter what to enhance their ad's appeal to the end user
Us vs. Them mentality
   Only list ads for pages within coop ad group
   Completely sheltered coop bubble
      Advertisers must mirror their sites into our system for approval and ad listing
         ensures end user privacy protection
Software interface required stops other advertisers from placing cookies unknowingly on users
   Ad Campaign
Orwellian depiction of internet today
   Big brother is always watching
   Retailers have access to too much information
   The more closely you guard your private information, the more value it is to you
      Retailers and advertisers will pay to gain that information, and already do, but you don't see any of that money. Where does it go? Clearing houses, search engine companies, publicly traded corporations
      It's your information they are paying for, so isn't it time you started seeing some of that money?
         Take control of your own destiny
         Join the coop, a coalition to ensure the protection of your identity
         Make money doing it
   Encourage networking through bonuses and such
Microsoft-Apple dichotomy
   Commercial: man sitting in front of a computer in the middle of a surreal white chamber. He browses Cashcow. Every time he clicks his mouse, the computer tower sitting next to the monitor spits out a dollar bill. Look of confusion on his face.
   Another: Same scenario, but with businessmen standing behind him. Every time he clicks, they chatter away and hand money back and forth. Suddenly, the man jumps up, the chair flies backwards, and he seizes the cash from the businessmen.
   Another: Same scenario, the man clicks. A UPS delivery man walks onscreen and taps him on the shoulder. Hands him a clipboard and a pen to sign. The man signs confusedly, then hands it back to the delivery man. The delivery man nods approvingly, then drops a fat bag of coins in a money sack with a $ on the outside into the users lap and walks off screen.

Title: U-Ad or YOUniverse

Coop: YOUnity

Learning Center: YOUniversity

Motto: “Join the YOUvolution!”
“Just U it!” (a la Nike)
   Establishes verb (like “Google it”)
      Factors in Determining User Quality Score

Click quality=conversions/clicks
Time- and keyword-specific search purposes
   Specified for each keyword search by a selection underneath the search toolbar
      Definite Buyer
         Brick and Mortar buyer?
         Increases click value to local advertisers, decreases to others
      Potential Buyer/Price Comparison
         Time frames to estimate when it will be bought
      Research to Buy
         Increases appeal to informational sites
      Just Browsing
      Rather Not Say
         Advertisers will determine their own Max CPC (cost per click) for unspecified users just like standard search engine
Join the Youniverse
   U-Ad
   U-Dollars

The system described herein can also be implemented through interactive television or radio, particularly via satellite television and radio systems and cable televisions systems.

Keyword advertising is booming across the internet today, and behind the scenes, money changes hands with every click of a user's mouse. Since the end user fuels the economics of online advertising, shouldn't a portion of the generated cash flow be directed towards that user? Logically, he or she is entitled to a piece of the action. Enter YouWe.

The YOUniverse system is constructed as a coop (or a standard corporation or a hybrid of the two), owned in a greater of lesser degree by its users (and investors, in the latter cases). Thus, some portion of profit generated that is not fed back into the growth of the company is distributed among its members, the end users.

When signing up for the YOUniverse system, the end user downloads (or fills out online) a profile generator to the hard drive and a customizable profile is securely stored for use by the YOUniverse engine.

The key to this profile is that it is completely up to the individual user how much information to provide. There are NO required fields except for the most standard information to set up a deposit/credit account with the YOUniverse system.

Beyond this, any information provided by the end user performs two main functions:
1. Enhances his click value to the advertiser, thus increasing the amount of money the user will make off of each click.
2. Increases the relevance of the advertisements shown in response to each keyword, potentially saving the user the time and energy of browsing by pointing him more directly towards what he wants.

Once created, the user profile is uploaded to the coop's user profile database and formulates a number to place them within a range of people within the database. That number defines how that user will be shown to the advertiser as buying potential. However, this profile database is dynamic, and any alterations the user wishes to make to the desktop profile will automatically upload to the online user profile database. Could be limited by honesty/normalcy tolerances provided by the Coop.

The search engine page has a standard, simple search engine interface for use as a standard search engine. It also has a user login option on the side. A user can only make money when he is logged into U-Ad. The standard search engine option may be useful for allowing people to get comfortable with the site and brand name before signing up.
Possibility of auto-login of some kind?
   U-Ad browser
   Password storage
   Homepage

Once logged in, the user can get paid while browsing, as well as manage his online U-Dollars account. The U-Dollars account works as a completely self-sufficient online banking system to add another level of security to online transactions by filtering them all through the U-Ad system. The online retailer no longer obtains any information from the end user during the transaction because the purchase is paid for using U-Dollars and paid out through the YOUniverse system. This further protects the end user from unsuspectingly giving out personal information and compels retailers/advertisers to join the YOUniverse system, because otherwise they cannot gather information about the types of users buying their products.

How the YOUniverse U-Dollars account online banking system works:
Credit account comes automatic with YOUniverse signup to track U-Dollars earned through browsing
Users can purchase additional U-Dollars to be used on any online transaction
   Protects information from retailer
   Verifies follow-through conversion on keyword search intentions, boosts click quality
The YOUniverse credit card can be ordered to use U-Dollars in physical transactions
   Also verifies purchases from “Brick & Mortar” retailers, boosts click quality

The search bar resembles any other search engine. Beneath the search bar, however, is a list of possible intentions that the user can click to tailor the search results and advertisements to his needs for that keyword search:
Definite Buyer
   Brick and Mortar buyer?
   Increases click value to local advertisers, decreases to others
Potential Buyer/Price Comparison
   Time frames to estimate when it will be bought
Research to Buy
   Increases appeal to informational sites
Just Browsing
Rather Not Say
   Advertisers will determine their own Max CPC (cost per click) for unspecified users just like standard search engine

After an intention is specified and the keyword search is submitted, the results are organized according to a user-specified ranking of factors. The advertisement results are dynamic columns that can be reorganized and reranked by:
Click Value (amount that advertisers are willing to pay for your click)
   Determined by advertiser, but based on specificity and details of user profile
Relevancy (as determined by normal search engine relevancy)
Product Price (if specific product)
Focus Spectrum—popularity among group of similar users, as specified by end user according to:
   Interests
   Income
   Demographics
   Etc.

The ads displayed in response to a search query have a few additional features compared to other search engine advertisements. Underneath the standard ad display, the YOUniverse ads display:
Click value
Focus Spectrum statistics

The Focus Spectrum is one of the most dynamic and uniquely appealing aspects of the YOUniverse search engine. In the profile generator, users specify not only their personal information, but the range of interests to which they would like their ads tailored. For example, a high-income user might want to only view ads for high-end consumer products. Rather than allow the advertiser to determine what the user wants to see, the engine uses a statistical grouping formula to determine other users with similar profiles in the specified area. Thus, a high-income user who selects income as a key focus spectrum factor would see the click and purchase choices of other high-income users displayed beneath the advertisements. The statistics show the percentage of similar users who decided to click on the product and the smaller percentage that followed through with a purchase/conversion.

The user also specifies the range of the Focus Spectrum to narrow or broaden the focus group. A simple focus statistics toolbar above the listing of advertisements has a customizable percentage that jumps between discreet amounts to change the range of the focus group. As the user expands or restricts the focus group size, the engine recalculates the relevancy of advertisements and adjusts their rankings accordingly.

All of the ads displayed in response to search queries are preapproved and within the YOUniverse network to ensure end user privacy in all click-throughs from a YOUniversal search. Our software/transfer page interface checks for cookies on landing sites to prevent pages within the ad network from tracking end users.

A user's click value directly affects the amount that user is offered by advertisers for clicking on an ad. The click value is based on:
Click quality—loosely determined by: (# of conversions)/(# of clicks)×100%
Demographic
Income level
Interests
Geographic location
Search Intentions
Any other profile information that the end user may provide

The click quality formula shows that the longer a user browses without making any purchases or other types of advertiser-defined conversions (leads, signups, page views, etc.), the lower the user's quality score drops.
Clicks always have an integer value (1 click=1 ad)
Conversions have variable values, not necessarily integers.
   For example:
   Sale=1
   Newsletter/Subscription=0.5
   Lead (request for follow-up call)=0.75
   Page View (length of visit)=0.05 ×(# of pages viewed after landing page)

Each advertiser can specify what aspects of a user's profile most enhance the click value to that advertiser. Thus, advertiser's can target demographics, income levels, interests, geographic locations, and search intentions to fit their specific product or goal, but only for each individual end user insofar as that user supplies the information. However, the advertiser can never obtain the identity of the specific end user unless the user agrees to provide some personal info. This is crucial to the security promise of the YOUniverse system.

The matching of users with relevant advertisers has a general formula based on the user-specified profile. With each keyword search, the engine uses a combination of overall click value and more significant and targeted keyword-specific click value to determine how much the advertiser is willing to pay.

The first factor in matching the user with relevant and interested advertisers is relevancy, which is based on:
the user-specified interests: advertisers create a similar interest page when creating an advertisement to select which users they would like to see their ads
the keyword itself: functions like a normal search engine, but combined with the other unique relevancy factors in determining the overall relevancy of ads
income level: for example, a high-end user would most likely buy camping supplies from REI than Target, and REI may pay more for the advertisement
Demographic: certain companies sell the same products but target different age groups
geographic location: local businesses that do not sell online or ship products are only concerned with local customers (based on IP address, user profile)

The relevant advertisers then scale the user based on:
The users self-expressed/determined buying potential (ex. “I promise to buy within 3 clicks”; “Frequent Buyer”; etc.)
Click value—performance history
Keyword-specific click value—performance history within the keyword-specified area

The focus spectrum uses complex statistical analysis of end user profile data to quantify the similarity of two users. The end user specifies what similarities are most important to him or her, and each keyword search groups other user data accordingly. The focus spectrum can be shifted based on:
Income
Demographic
Interests/Hobbies
Geographic location (IP address)
Conversion Rate
   Frequent Buyer
   Occasional Buyer
   Brick and Mortar Buyer
   Rare Buyer

One or more factor can be selected to filter the advertisements even more thoroughly. For example, let's say an 18 year old female is searching for digital cameras online. The focus spectrum uses the groupings according to her demographic (16-20, persay) and expressed interest in professional photography to quantify the relevancy of the advertisements based on other similar users. The resulting ad rankings display the advertisements for higher-end cameras that garnered the most click-throughs and conversions among the 16-20 year old demographic. If she wanted to expand the search to high-end digital cameras among all ages, she could deselect the demographic factor and focus solely on the most popular and successful advertisements among those with an interest in professional photography.

Click quality=conversions/clicks
Time- and keyword-specific search purposes
   Specified for each keyword search by a selection underneath the search toolbar
      Definite Buyer
         Brick and Mortar buyer?
         Increases click value to local advertisers, decreases to others
      Potential Buyer/Price Comparison
         Time frames to estimate when it will be bought
      Research to Buy
         Increases appeal to informational sites
      Just Browsing
      Rather Not Say
         Advertisers will determine their own Max CPC (cost per click) for unspecified users just like standard search engine

Meetings:
List the value of end user's click underneath the ad
   States amount paid to get through and the determined relevancy factor
Focus spectrum: Based on statistical data about other users with similar profile
   Personalized data to provide information on other conversion profiles
      Variable matching—within 5%, 10%, etc.
Ad matrix—customizable ad ranking
   More robust targeting mechanism for the end user, not the advertiser
      Makes transparent the behind-the-scenes workings of Google and other search engines
      Can view statistics for other buyers without revealing the identity of those other buyers
   Can prioritize ad rankings by:
      Price (that advertisers are willing to pay for your click)
      Relevancy
      Focus Spectrum (based on end user-specified group of similar users)
         Interests
      Intention (serious buyer, research, etc.)
Privacy—advertisers see only delivery #'s for UPS, not personal buyer info
   Complete self-sufficient banking online allows complete anonymity for end user
      Buy online $ through Cashcow credit card, spend the $ on online products, retailer ships to UPS
      UPS ships to local address based on unique scan code
         Code changes with every transaction
Bonuses for survey information provided in addition to click/conversion dollars
   Lead bonuses—newsletters, subscriptions, etc.
Time-dependent click value
   Model for checking veracity of user click intention
      For example, if claim “Definite Buyer,” the user will be paid the full amount promised by the advertiser only if they follow through with a conversion within the given time frame
      If the user does not follow through, the initial $X paid for the amount will be cut to a fraction determined by the advertiser
         Retailer can also choose not to cut cost no matter what to enhance their ad's appeal to the end user
Us vs. Them mentality
   Only list ads for pages within coop ad group
   Completely sheltered coop bubble
      Advertisers must mirror their sites into our system for approval and ad listing
         ensures end user privacy protection
Software interface required stops other advertisers from placing cookies unknowingly on users
YOUniverse, YouWe, U-Ad, YouGo, OK?
Hybrid—stock, but as value increases they reach a threshold, and everything above that line goes back/can be bought back by the coop
Ex. High-end camping gear purchaser, traveler—would not fit Target's profile, more REI status
User profile numbers could be 100 digits long or more
   Only specific digits apply to each advertiser
   i.e. there is a number for camping specifically
Matching system
   Joins 2 people together
   We want to join buyer and advertiser
      Includes not just user-defined information, but performance-based info
   “I promise to buy within the first 3 clicks”
Rating sites by other users
   User can select to show results with only certain ratings
Time in business
Create matrix in excel
Click value scales the maximum cost per click
Rate different aspects of advertisers to tailor business to end user preference
   Focus Spectrum Expanded

The focus spectrum uses complex statistical analysis of end user profile data to quantify the similarity of two users. The end user specifies what similarities are most important to him or her, and each keyword search groups other user data accordingly. The focus spectrum can be shifted based on:
Income
Demographic
Interests/Hobbies
Geographic location (IP address)

Certain factors come into play more often than others. For example, geographic location is a much less significant factor than income, especially when searching for computer hardware, persay. The geographic location may come into play much more when searching for sleeping bags. In this way, the combination and weight of the different qualifiers in creating a focus spectrum for each individual search is dynamic and largely dependent on the keyword itself.

One or more factor can be selected to filter the advertisements even more thoroughly. For example, let's say an 18 year old female is searching for digital cameras online. The focus spectrum uses the groupings according to her demographic (16-20, persay) and expressed interest in professional photography to quantify the relevancy of the advertisements based on other similar users. The resulting ad rankings display the advertisements for higher-end cameras that garnered the most click-throughs and conversions among the 16-20 year old demographic. If she wanted to expand the search to high-end digital cameras among all ages, she could deselect the demographic factor and focus solely on the most popular and successful advertisements among those with an interest in professional photography.

The number derived from the focus spectrum is the Relevancy Factor of the ad for those within the spectrum. This percentage is displayed underneath each advertisement to show how relevant other users thought that advertisement to be.

The percentage is based not solely on click-throughs, but also on conversions. A conversion is worth significantly more than a click-through. Accordingly, the number generated, although a percentage, is not solely (clicks)/(impressions) for the focus group. It may look something more like [(clicks)+100*(conversions)]/(impressions)

For a definite buyer, (conversions)/(clicks) for the focus spectrum may be more useful information.

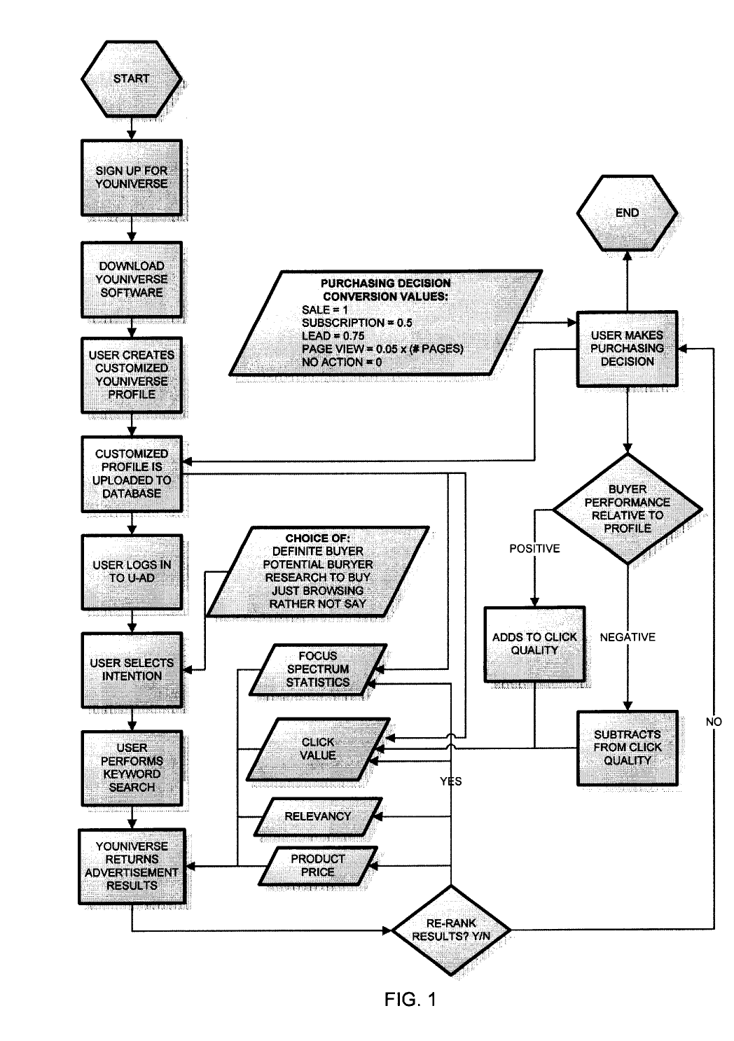

FIG. 1 is a flowchart of a particular system for purchasing goods online. The end user signs up for the YOUniverse system and downloads YOUniverse software for use on a local computer. The user then uses the YOUniverse software to create a customized YOUniverse profile, which may include one or more of demographic information, income level, interests/hobbies, geographic location, type of buyer, and search intentions. The user then uploads the customized profile to a YOUniverse database. The YOUniverse system assigns an initial Click Value to the user based on profile information. The customized profile is also used to determine Focus Spectrum Statistics, which encompasses the range of interests for the ads that the user will view.

The user then logs in to U-Ad and selects an intention, specifying a choice of definite buyer, potential buyer, research to buy, just browsing or rather not say. The user then performs standard keyword searches for items and the YOUniverse system returns advertisement results based on the Focus Spectrum Statistics, Click Value, relevancy and product price. The user then has a yes/no choice to rerank the results based on any of these factors. Choosing yes allows the user to rerank the results and obtain a new set of advertisement results based on the user's choice. Choosing no allows the user to continue to make a purchasing decision. Depending on the nature of a purchasing decision, the YOUniverse system assigns a conversion value based on Sale=1; Subscription=0.5; Lead=0.75; Page View=0.05×(# of pages); and No Action=0.

Purchasing decision information is used to adjust Click Value. A positive performance adds to Click Quality and a negative performance subtracts from Click Quality. These Click Quality values are then used to adjust the user's Click Value.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

1. A method for using a global computer network to search for and purchase goods, the method comprising:
storing profile information for a user, the profile information being selected from demographics, income level, interests/hobbies, geographic location, type of buyer, search intentions, and combinations thereof;
providing a search engine by which the user searches for goods or services of interest to the user;
supplying advertisement results to the user in response to search requests made via the search engine, the advertisement results being keyed to the profile information, focus spectrum statistics, click value, relevancy, and product price;
noting properties of any purchase decision made by the user in response to search requests made via the search engine;
updating the user's click value to reflect the properties of the purchase decision; and
providing an award to the user, the award being determined, at least in part, by the user's click value.
